(19) United States
(12) Patent Application Publication
(10) Pub. No.: US 2010/0079580 A1
(43) Pub. Date: Apr. 1, 2010

(54) Apparatus and method for biomedical imaging

(76) Inventor: George O. Waring, IV, Kansas City, MO (US)

Correspondence Address: MCKENNA LONG & ALDRIDGE LLP, 1900 K STREET, NW, WASHINGTON, DC, 20006, US

(21) Appl. No.: 12/285,233

(22) Filed: Sep. 30, 2008

(51) Int. Cl. H04N 13/00; H04N 5/225

(52) U.S. Cl. 348/44; 348/207.11; 348/E05.024; 348/E13.001

(57) ABSTRACT

This is an imaging system configured and optimized for capturing two dimensional images of a desired section of body tissue and converting these images into three dimensional virtual environment images. These three dimensional virtual environment images are then viewed at multiple immersive omnidirectional viewing angles. The viewing angles are then choreographed into a desired sequence to create a fly through sequence through the cellular layers of a desired section of body tissue.

### BACKGROUND OF THE INVENTION

1. Field of the Invention

The present invention relates to an imaging system, and more particularly, to an imaging system, which displays multiple viewing points and immersive omnidirectional viewing for a three dimensional fly through image of a cornea.

2. Discussion of the Related Art

Transparency, avascularity, and immunologic privilege make the cornea very difficult to examine. In a conventional imaging device, two dimensional images are used to create three dimensional images of the cornea. However, due to limitations associated with the processing of large amounts of two dimensional images into three dimensional images, and the transparent nature of the cornea, conventional three dimensional images of the cornea and other areas of the patient's body do not allow the viewer to view the images from multiple viewing points, as well as multiple viewing points wherein the viewer has the capability to immerse their viewing perspective from within the cornea or body area of interest tissue itself at a cellular layer. Without the ability to view the cornea or body area of interest from a multiple of viewing angles around the cornea or area of interest looking in and as well as from within the cornea or area of interest itself, the patient and doctor can not obtain the best perspective. Currently Fourier domain Optical coherence tomography (OCT) like other imaging modalities are limited to omnidirectional volumetric three dimensional viewing of the cornea or selected body areas of interest. Therefore, there is a need to create the ability to view the transparent structure of a cornea or other body areas of interest while allowing the viewer to examine the area of interest from multiple viewing points, including multiple viewing points from within the cornea's tissue or the tissue area of interest. Therefore, allowing the viewer to immerse their viewing angles within the cellular layers for any chosen tissue of the body.

Conventional three dimensional imaging of the cornea or body does not allow the viewer to pass through the cellular layers of the tissue with a single pass. It is desirable to gain the spatial relationship needed to evaluate the tissue images and allow multiple three dimensional viewing angles and images of the tissue with a single glance. Having the ability to create a single pass will enable the viewer of the multiple viewing angles and images to get a sense of spatial relationship between all the cellular layers of the cornea or body area of interest. With the ability to view the cornea or body area of interest with a single pass, the patient or physician can then plan a trip through the tissue where they may selectively choreograph the viewing of multiple cellular layers of interest, while still maintaining at a single glance, relative spatial relationship of each cell and cellular layer. In an alternate embodiment a mouse or joystick is used to control this single pass to eliminate the planning of the trip through the tissue. This will allow the viewer to direct the pass through and around the cells and their layers with a single touch of the joystick.

### SUMMARY OF THE INVENTION

Accordingly, the present invention is directed to cornea imaging or any structure of the body, including the eye or nervous system, that substantially obviates one or more of the problems due to limitations and disadvantages of the related art.

An advantage of the present invention is to provide an imaging system, comprising: an imaging device for capturing two dimensional images; a computer operably connected to the imaging device controlling the imaging device; the computer having an image extraction software for controlling the capture of two dimensional images, the computer having a post production software for converting the two dimensional images into a three dimensional virtual environment image, creating multiple viewing points of the three dimensional virtual environment image, and for creating immersive omnidirectional viewing within the three dimensional virtual environment image; an input device connected to the computer for receiving commands; and an output device connected to the computer for displaying images.

Another advantage of the present invention is to provide an imaging method, comprising: optimizing an imaging device; capturing two dimensional images; converting the two dimensional images into a three dimensional virtual environment image; and creating a fly through sequence.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. To achieve these and other advantages and in accordance with the purpose of the present invention, as embodied and broadly described, an imaging system, comprising: an imaging device for capturing two dimensional images; a computer operably connected to the imaging device controlling the imaging device; the computer having an image extraction software for controlling the capture of two dimensional images, the computer having a post production software for converting the two dimensional images into a three dimensional virtual environment image, creating multiple viewing points of the three dimensional virtual environment image, and for creating immersive omnidirectional viewing within the three dimensional virtual environment image; an input device connected to the computer for receiving commands; and an output device connected to the computer for displaying images.

In another aspect of the present invention, An imaging method, comprising: optimizing an imaging device; capturing two dimensional images; converting the two dimensional images into a three dimensional virtual environment image; and creating a fly through sequence.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram of the imaging system.

FIG. 2 is a block diagram of a computer and its relating software.

FIG. 3 is a flowchart relating to the high level process involved in creating a three dimensional fly through image of a cornea.

FIG. 4 is a flowchart relating to the process involved in optimizing the imaging device.

FIG. 5 is a flowchart relating to the process involved in the capturing of two dimensional images.

FIG. 6 is a flowchart relating to the process involved in converting two dimensional image data to three dimensional images.

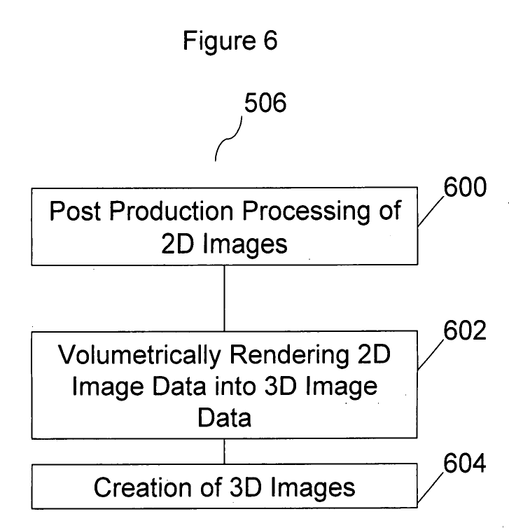

FIG. 7 is a flowchart relating to the process involved in the creation of fly through images.

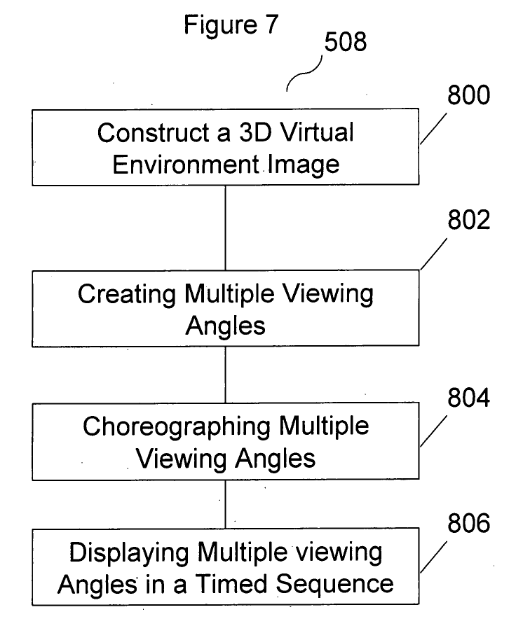

### DETAILED DESCRIPTION OF THE ILLUSTRATED EMBODIMENTS

Reference will now be made in detail to an embodiment of the present invention, example of which is illustrated in the accompanying drawings.

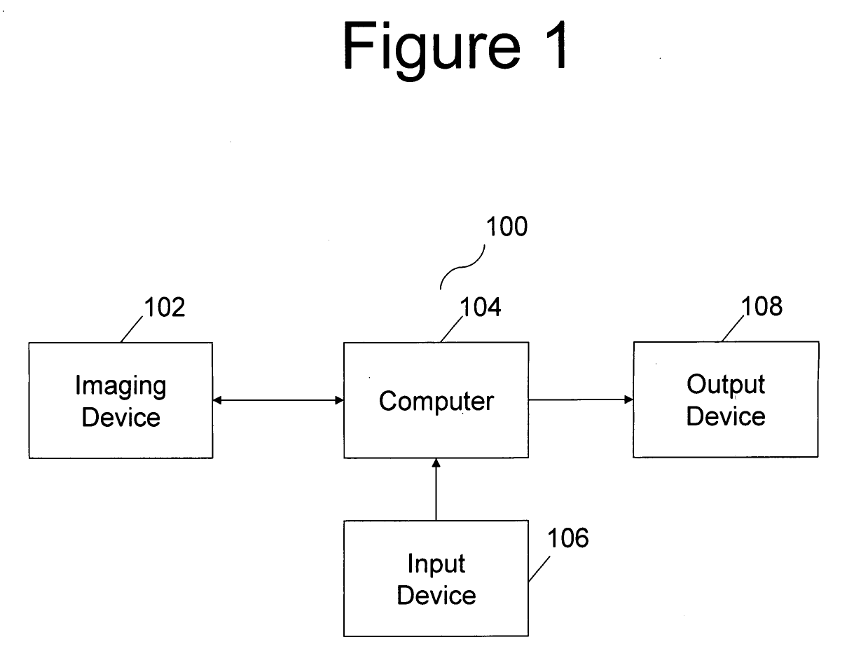

FIG. 1 is an example of one of many embodiments of the present invention. The imaging system of FIG. 1 consists of an imaging device 102, computer 104, input device 106, and output device 108. The imaging device 102 is used for capturing two dimensional images, and subsequently creating two dimensional image data. This two dimensional image data is then converted to a three dimensional images by using a computer 104 with software. The user through the use of input devices 106 may then view the three dimensional images from a multitude of viewing angles, and has the ability to immerse the viewing points from within the three dimensional image. These three dimensional images are then sequentially choreographed to create a fly through sequence of the images. This sequence is then displayed through an output device 108 that is attached to the computer. The output device 108 can be any device that displays images and is not limited to a monitor, television, liquid crystal display, or plasma screen. Also, the input device 106 can be any device that allows a user to input commands into the computer 104 and is not limited to only a keyboard, mouse, stylus, or voice command receiver.

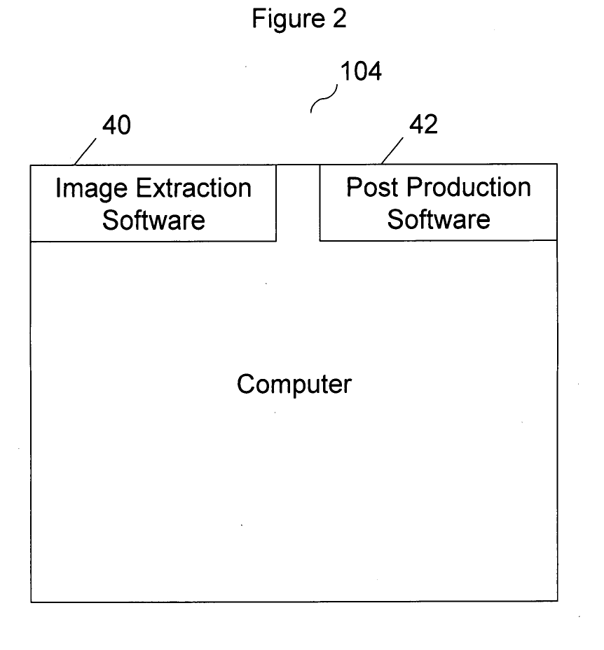

FIG. 2 is an example of a computer. For controlling the imaging device 102 the computer 104 can contain image extraction software 40, or the imaging device itself can contain the image extraction software (not shown in the figures). Usually it is the imaging device that contains the image extraction software. Different imaging devices will require different image extraction software. For a chosen imaging device the image extraction software should be compatible with the particular imaging device chosen. One type of image extraction software 40, which can be used for controlling the imaging device 102, is the software produced by Nidek Inc., located at 34-14, Maehama, Hiroishi-cho, Gamagori, Aichi 443-0038 JAPAN, under the trademark “Navis.” Preferably the confocal microscope contains and is compatible with Navis software. It is also preferable that the Navis software version used is a version compatible with the particular confocal microscope version or model. Version 4 of the confocal microscope produced by Nidek is preferred along with the Navis software versions compatible with this version of microscope. The computer 104 may also contain post production software 42 as seen in FIG. 2, or the imaging device itself may contain post production software 42 (not shown in the figures). It will be apparent to those skilled in the art that the post production software 42 can also be combined with the image extraction software 40 as a single application for image extraction and manipulation(not shown in the figures). However, post production software 42 whether combined with the image extraction software 40 or used as a separate application, is preferably used to manipulate the images extracted to create a three dimensional fly through image.

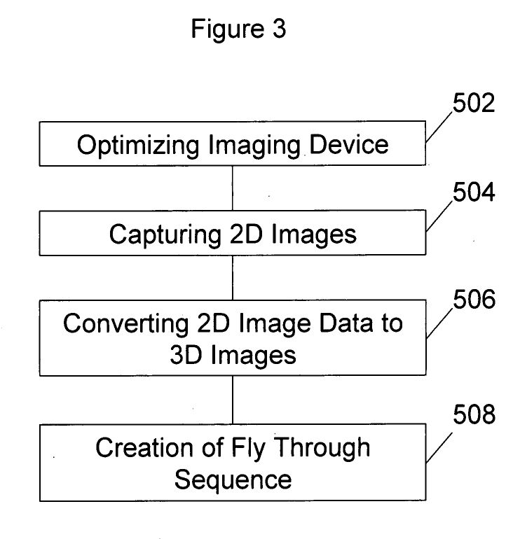

FIG. 3 is a block diagram of one embodiment displaying the procedures involved in creating a three dimensional fly through image. The procedure of optimizing the imaging device 502 is used to prepare the imaging device 102 for capturing two dimensional images 504. Next, the captured images are converted from two dimensional images to three dimensional images in the procedure converting two dimensional image data to three dimensional image data 506. Post production processing of the three dimensional image data 508 is then performed to create a fly through view of the 3D image data. Finally, the fly through view of the 3D image data is displayed through the use of the output device 108 in the procedure displaying fly through images 510. Each procedure in FIG. 3 will now be explained in further detail below. The imaging device 102 can be any digital imaging device or medical imaging device used to capture images of the body of a patient including but not limiting to such parts as the eye or nervous system of the body. The imaging device 102 preferably has the capability to capture images at a cellular level to view the cells and cellular layers located within the eyes, nervous system, or generally any body part of a patient. The imaging device 102 can be a tomograph or volume imaging device. The tomograph or volume imaging device can be, but is not limited to the following types of tomograph: computed tomography, single photon emission computed tomography (CT), positron emission tomography (PET), magnetic resonance imaging (MRI), or nuclear magnetic resonance imaging (NMRI), medical sonography (ultrasonography), transmission electron microscopy (TEM), atom probe, and synchrotron X-ray tomographic microscopy (SRXTM). The imaging device 102 can also use combinations of the above mentioned types of tomograph such as but not limited to combined CT/MRI and combined CT/PET. The imaging device 102 can be, but is not limited to imaging devices or types of imaging devices using the following types of tomography; Atom probe tomography (APT), Computed tomography (CT), Confocal laser scanning microscopy (LSCM), Cryo-electron tomography (Cryo-ET), Electrical capacitance tomography (ECT), Electrical resistivity tomography (ERT), Electrical impedance tomography (EIT), Functional magnetic resonance imaging (fMRI), Magnetic induction tomography (MIT), Magnetic resonance imaging (MRI), formerly known as magnetic resonance tomography (MRT) or nuclear magnetic resonance tomography, Neutron tomography, Optical coherence tomography (OCT), Optical projection tomography (OPT), Process tomography (PT), Positron emission tomography (PET), Positron emission tomography-computed tomography (PET-CT), Quantum tomography, Single photon emission computed tomography (SPECT), Seismic tomography, Ultrasound assisted optical tomography (UAOT), Ultrasound transmission tomography, X-ray tomography (CT, CATScan), Photoacoustic tomography (PAT), also known as Optoacoustic Tomography (OAT) or Thermoacoustic Tomography (TAT), Zeeman-Doppler imaging, The imaging device 102 can be, but is not limited to imaging devices or types of imaging devices using the following techniques: Confocal microscopy, Electron microscopy, Fluoroscopy, Tomography, confocal microscopy imaging, Photoacoustic imaging, Projection radiography, Scanning laser ophthalmoscopy, Confocal laser scanning microscopy (CLSM or LSCM), slit lamp photography, Scheimpflug photography, Heidelberg Retinal Tomograph, and Heidelberg Retinal Tomograph II (HRT II). Preferably a confocal microscopy imaging device is used to capture images at a cellular level. However, many of the aforementioned imaging devices or types tomographs can be used to capture information at the cellular level. Functional imaging devices can be used to capture nerve activity of the patient at a cellular level. Through the use of confocal microscopy imaging, the imaging device 102 has the ability to capture two dimensional images of a body part, eye, or more specifically the cornea of the eye. An example of one type of imaging device 102 used is the corneal confocal microscope produced by Nidek Inc., (noted above) under the trademark “Confoscan 4.”

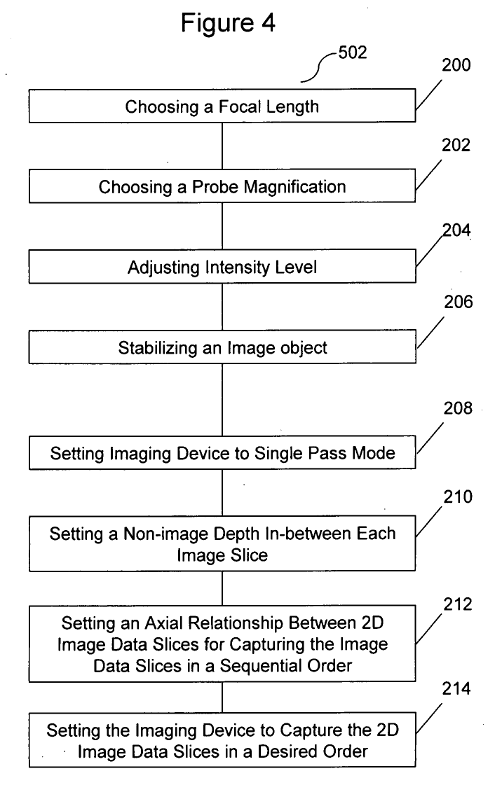

FIG. 4 will now be referenced to illustrate the procedures involved in the optimization of the imaging device 102. In optimizing the imaging device 102 the corneal confocal microscope is equipped with a fixed focal length 200 of 26 microns. To further optimize the imaging device 102, the chosen magnification probe 202 should be a 40× magnitude. When capturing 2D images with a corneal confocal microscope or imaging device, it is also preferable that the device have an intensity level adjuster to allow adjustment of the intensity level 204 used in capturing the images. This intensity level adjuster will allow for the minimization of the light reflection caused when the individual cellular images are captured. The intensity level of the corneal confocal microscope is preferably set at a level of 90 on the Nidek microscope. The imaging device 102 should also be equipped with an object stabilizer for stabilizing an image object 206, or more specifically the eye, during imaging of the cornea. Stabilizing an image object 206 will allow the imaging device 102 to align multiple two dimensional images by minimizing the movement of the cornea between images. This will also allow each individual cell or cell layer to be aligned with each two dimensional image. One example of an image object stabilizer is the type produced by Nidek Inc., under the trademark “Z-Ring.” Once the settings are performed, axial slices of the cornea are preferably captured at different depth levels in a sequential order 212. This is preferable to capturing radial images. Though it is preferable to capture images with an axial relationship to one another the images can also be captured with a multitude of relationships such as, but not limiting to, coronal, sagittal, transverse, or radial relationships. However if a radial relationship is used to capture the images radial interpolation is performed to place the images into the desired format for three dimensional imaging. To increase accurate and reproducible image data, the imaging device should be set to single pass mode 208. Single pass mode will allow the images to be captured automatically after initializing image capture with the imaging device. The imaging device 102 should also be equipped with a depth adjuster for setting a minimum distance to the non-image depth in-between each image slice captured. The non-image depth in-between each image slice captured will depend on the imaging modality or device used. For example, the Confoscan imaging devices can be, but are not limited to a minimum non-image depth of 1.5 or 2 microns in-between each image slice captured. This reduces the image loss between images and optimizes the amount of images captured while using single pass mode. Also, by capturing images using a single pass mode, the image slices throughout the cornea can be recorded automatically in a sequential order according to the relative depth between image slices of the eye. This will prevent having to reorder the image slices according to their relative depths. With the settings mentioned above the user can view, magnify, measure, and photograph separate layers of the transparent structures and tissue of the cornea. Also, image extraction software 40 associated with the capturing of the two dimensional images may be used to control the desired settings mentioned above. For example, NAVIS, created by NIDEK Inc., may be used to control the desired settings mentioned above.

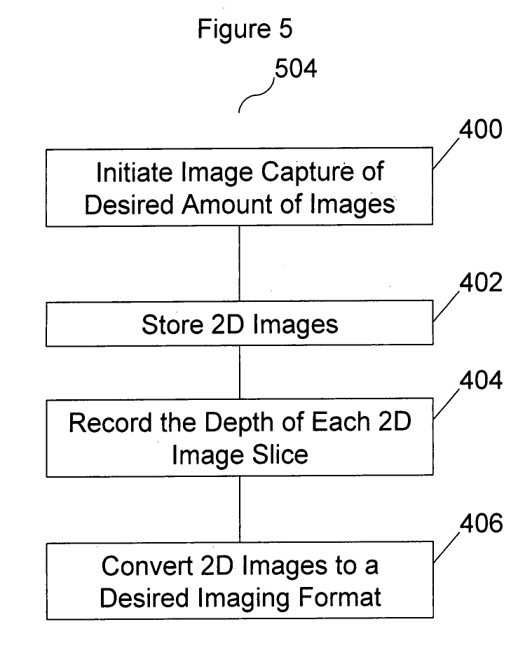

Referring back to FIG. 3, after optimizing the imaging device 502 the two dimensional images of the body or eye and their respective cells and cellular layers are captured 504 using the imaging device. Referring now to FIG. 5, the imaging device 102 is used in conjunction with the computer 104, input device 106, and output device 108 to initiate image capture of the desired amount of images 400. The preferred amount of two dimensional images is between three hundred and fifty to five hundred images for a cornea when using a Confoscan imaging device. This preferred amount of two dimensional images may be greater or less but the maximum number of images to be captured depend on the number of images needed to create a smooth fly through sequence of the body area of interest while minimizing or choosing a desired computer processing time it takes to process all of the images.

After capturing the desired amount of two dimensional images 400, the images are stored 402 within the memory of the computer 104 or device for storage. Upon storing the 2D images, the depth of each two dimensional image slice is recorded 404 at a specified tissue or cornea depth with the use of the image extraction software 40. This entails mapping out the depth or associating a depth location in relation to the eye for each 2D image slice being recorded, thereby maintaining each slice's known positioning depth within the eye. The 2D images are also converted to a desired imaging format 406. Preferably, the 2D images are set to a specified format by converting the 2D image data to a standard imaging format, such as but not limited to a JPEG or bitmap format.

After converting the 2D images to a desired imaging format 406, the post production software 42 is used for post production processing of the 2D images 600. One example is the type of software developed by Mayo Clinic, located in Rochester, Minn., and distributed by AnalyzeDirect located at 7380 W. 161^{st} Street, Overland Park, Kans., 66085 USA, under the trademark “Analyze 6.0,” software version 6.0. This application is described in a publicly available document entitled “Analyze 6.0 Users Manual,” and available at http://www.analyzedirect.com/support/downloads.asp#6doc (follow “Analyze 6.0 Users Manual” hyperlink), the entirety of which is incorporated by reference herein. Preferably version 8.1 Analyze is used as the post production software 42. However different software versions such as, but not limiting to, Analyze 7.0 or Analyze 6.0 can be used as post production software 42.

There are multiple ways to import the 2D image data into the post production software 42 or Analyze software. One way to import 2D image data is to use the import/export tool which allows for the importing of multiple JPEG files. Preferably, the load as tool can be used to import a single audio video interleave file containing the 2D image data. Then, the 2D image data is loaded as a 3D volume using the tools in Analyze, preferably the Getting the Images into Analyze tools. After importing and loading the 2D images, the Analyze tools allow for appending the 2D images as a single volume, and this can be performed using the Appending tools or with the Volume tool. Also, the Wild Card tool can be used to select files using a filter to import files that match a certain predefined parameter or parameters of the 2D images.

Next, using the Analyze software, the Multiplanar tools and Scan tools allow reviewing of the 2D image data slice by slice. Then, the voxel output dimensions of the 2D images are adjusted using the cube sections tool along with the Multiplanar Sections tools, and the 2D and 3D Registration tools to align and unify the dimensions associated with the multiple image data. This prevents and minimizes the images from being stretched in one or more dimensions. Then, depending on the types of images desired certain dimensions can be set to pad or crop the space around the images as a whole using the Analyze software tools.

After importing all of the 2D images, post production begins using the Rendering tools of the Analyze software to create a final fixed 3D image of a desired area of interest at a cellular level. More specifically, post production processing entails converting the 2D imaging data to build three dimensional (3D) image data to display a 3D image. However, to first convert the 2D imaging data to 3D images, the 2D imaging data is volumetrically rendered 602 with the Analyze software. Volumetrically rendering the 2D imaging data can be performed at any time using the Analyze software to verify the 3D image being produced is what is desired. When the 2D imaging data is volumetrically rendered 602 to create 3D imaging data, the 3D imaging data is also optimized to create an apparent, maximum depth of field through the cellular tissue levels while maintaining image clarity of the cellular tissue due to the transparent nature of the cornea or eye. Accordingly, this creates a balance between making the cellular elements as transparent as possible to maximize the depth of field through the levels of cornea or eye tissue, while still maintaining the image clarity by creating enough contrast within the cornea's or eye's cellular tissue to allow the viewer to distinguish the individual cellar layers and cells of the cornea or eye. This optimization is preferably done using the Analyze software program using the rendering tools and volume rendering tools. It should be appreciated that the general concepts of this invention described herein, in particular the optimizing a maximum depth of field through the cellular tissue levels while maintaining image clarity of the cellular tissues, can also be performed on other parts of the body not limited to only the eye, cornea or the nervous system.

Once the three dimensional imaging data is optimized, the data is then used to create 3D images 604 of the cornea or body parts of interest which are used to construct a three dimensional virtual environment image 800 of the corneal cells or body cells and cellular layers of the body or cornea. The creation of the three dimensional virtual environment image 800 of the corneal or body cells and cellular layers are performed by using the Analyze software. This 3D virtual environment imaging encompasses the concept of allowing a user to interact with a computer-simulated environment of a real object. In this case the real object being a cornea or body part of interest. The 3D image may then be edited, sized, and dimensionally aligned using the Clip, Threshold, and Render type tools of the Analyze software.

Then, multiple viewing angles are created using the Analyze software, in step 802, of the 3D virtual environment image. This 3D virtual environment image will eventually be displayed on the output device 108 using the Analyze software. In creating the multiple viewing points, the creator may use input devices 106 such as, but not limiting to, a touch screen, stylus, keyboard, mouse, voice command receiver, to manipulate the viewing angles at which the 3D virtual environment image will eventually be displayed. In an alternate embodiment one can use a mouse or joystick to control the viewing angles of the 3D virtual environment image and direct the fly through sequence in real time. In the alternative embodiment the real time manipulation of the fly through sequence is performed by using a gaming engine and/or visualization and computer graphics tools for processing the large datasets accompanied with the real time manipulation of tissue models.

Also, the post production software 42 or Analyze software will allow for omnidirectional viewing of the 3D virtual environment image upon the output device 108. It should be noted that omnidirectional viewing is a viewing concept that allows a viewer to view an object of interest from multiple viewing angles or directions. Not only does the present invention allow the user to view the cornea or body area of interest in three dimensions from a multitude of perspective angles, the invention also allows for immersive omnidirectional viewing within the 3D virtual environment image. Immersive omnidirectional viewing is the concept of allowing the viewer to view a 3D image from multiple viewing angles while the viewing perspective is immersed within the boundaries of the three dimensional image or geometric object. This immersive omnidirectional view or camera angles and positions are then created using the volume render display tool, perspective tools and volume rendering tools of the Analyze software.

The multiple viewing angles are then choreographed 804 in a sequential manner using the volume render tools and perspective rendering tools of the Analyze software to plan and create a fly through sequence. The path of the fly through sequence is customized using the Analyze software to fly through and around the desired areas of interest depending on what is being imaged with the cornea or other selected areas of the patient's body including but not limiting to the nervous system. In an alternate embodiment the path of the fly through sequence can be controlled by a joystick to fly through and around the areas of interest. This customized fly through sequence can then be saved or recorded as a predefined camera routine for later use on different cornea images using Analyze software tools including but not limited to the Movie tools. The fly through sequence will give the viewer the unique sense of the ability to fly through, into, and around the 3D images of the cornea or areas of interest pertaining to a patient's body, when the multitude of perspective angles are being displayed 806 in a timed sequence from the output device 108. The visual sense of flying through the cornea or area of interest will allow the patient, physician, or viewer to obtain a complete and comprehensive perception of the spatial relationships involved at a cellular level with the viewing of a patient's cornea or body area from both the inside and outside of the cells and cellular layers rather than a two dimensional slice by slice view of the viewing object.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An imaging system, comprising:
an imaging device for capturing two dimensional images;
a computer operably connected to the imaging device for controlling the imaging device;
the computer having an image extraction software for controlling the capture of two dimensional images,
the computer having a post production software for converting the two dimensional images into a three dimensional virtual environment image, creating multiple viewing points of the three dimensional virtual environment image, and for creating immersive omnidirectional viewing within the three dimensional virtual environment image;
an input device connected to the computer for receiving commands; and
an output device connected to the computer for displaying images.

2. The imaging system of claim 1, wherein the imaging device is a corneal confocal microscope.

3. The imaging system of claim 1, wherein the imaging device is a tomographic imaging device.

4. The imaging system of claim 1, wherein the imaging device is a functional imaging device.

5. The imaging system of claim 1, wherein the imaging device converts a two dimensional image into two dimensional image data.

6. The imaging system of claim 1, wherein the imaging device further comprises having a fixed focal length.

7. The imaging device of claim 2, wherein the fixed focal length is 26 microns.

8. The imaging system of claim 1, wherein the imaging device further comprises having a magnification probe.

9. The imaging device of claim 2, wherein the imaging device further comprises having a magnification probe.

10. The magnification probe of claim 9, wherein the magnification probe is a 40× magnification.

11. The imaging system of claim 1, wherein the imaging device further comprises having an intensity level adjuster.

12. The imaging system of claim 1, wherein the imaging device further comprises having an object stabilizer.

13. The imaging device of claim 2, wherein the imaging device further comprises having an object stabilizer.

14. The object stabilizer of claim 13, wherein the object stabilizer is a z-ring.

15. The imaging system of claim 1, wherein the imaging device further comprises having a single pass mode.

16. The imaging system of claim 1, wherein the imaging device further comprises a depth adjuster.

17. The imaging system of claim 2, wherein the imaging device further comprises a depth adjuster.

18. The depth adjuster of claim 17, wherein the depth adjuster is set to 2 microns or less.

19. The imaging system of claim 1, wherein the two dimensional images have an axial relationship with respect to each two dimensional image.

20. The imaging system of claim 1, wherein the two dimensional images are captured in sequential order.

21. The imaging system of claim 1, wherein the software converts the images to a specified format, and associates a tissue depth with each two dimensional image.

22. The imaging system of claim 1, wherein the post production software is used to create a fly through sequence.

23. An imaging method, comprising:
optimizing an imaging device;
capturing two dimensional images;
converting the two dimensional images into a three dimensional virtual environment image; and
creating a fly through sequence.

24. The imaging method of claim 23, wherein optimizing an imaging device further comprises:
fixing a focal length;
setting a probe magnification;
adjusting an intensity level;
stabilizing an image object;
setting the imaging device to a single pass mode;
setting a non-image depth in-between each image slice;
setting a relationship between two dimensional images; and
setting a desired order for capturing the two dimensional images.

25. The imaging method of claim 23, wherein capturing two dimensional images further comprises:
initiating capture of an optimal amount of two dimensional images; and
associating a depth location with each two dimensional image.

26. The imaging method of claim 23, wherein converting the two dimensional images into a three dimensional virtual environment image further comprises:
volumetrically rendering two dimensional image data into three dimensional image data;
optimizing the three dimensional image data; and
creating three dimensional images.

27. The imaging method of claim 23, wherein creating a fly through sequence further comprises:
constructing a three dimensional virtual environment image;
creating multiple viewing angles; and
choreographing multiple viewing angles.

28. The imaging method of claim 23, wherein creating a fly through sequence further comprises:
displaying multiple viewing points of the three dimensional virtual environment image; and
displaying immersive omnidirectional viewing within the three dimensional virtual environment image.

29. The imaging method of claim 23, wherein the imaging method further comprises: using a corneal confocal microscope for producing two dimensional imaging data.

30. The imaging method of claim 23, wherein the imaging method further comprises using a tomographic imaging device.

31. The imaging method of claim 23, wherein capturing two dimensional images comprises:
capturing two dimensional image slices of a tissue at multiple depths with a single pass.

32. The imaging method of claim 24, wherein setting a relationship between two dimensional images further comprises:
setting an axial relationship between the two dimensional images.
